(19) United States
(12) Patent Application Publication
(10) Pub. No.: US 2010/0053848 A1
(43) Pub. Date: Mar. 4, 2010

(54) NIOBIUM SOLID ELECTROLYTIC CAPACITOR

(75) Inventors: Kazuhito Kikuchi, Hirakata City (JP); Mutsumi Yano, Hirakata City (JP); Kazuhiro Takatani, Amagasaki City (JP); Hiroshi Nonoue, Hirakata City (JP)

Correspondence Address: MOTS LAW, PLLC, 1629 K STREET N.W., SUITE 602, WASHINGTON, DC, 20006-1635, US

(73) Assignee: SANYO ELECTRIC CO., LTD, Osaka (JP)

(21) Appl. No.: 12/548,546

(22) Filed: Aug. 27, 2009

(30) Foreign Application Priority Data
Aug. 29, 2008 (JP) 2008-222355

(51) Int. Cl. H01G 9/025

(52) U.S. Cl. 361/523; 361/525

(57) ABSTRACT

A niobium solid electrolytic capacitor comprises: an anode mainly made of niobium and containing nitrogen and at least one kind of alloying element whose hardness is higher than that of niobium; a dielectric layer provided on a surface of the anode and containing nitrogen; an electrolyte layer provided on the dielectric layer and formed of a conductive polymer; and a cathode layer provided on the electrolyte layer. The electrolyte layer has a three-layered structure formed of a first electrolyte layer, a second electrolyte layer, and a third electrolyte layer, which are arranged in this order between the dielectric layer to the cathode layer. The second electrolyte layer and the third electrolyte layer contain alkyl substituted aromatic sulfonate. Conductivities of the respective electrolyte layers increase in order of the first electrolyte layer, the second electrolyte layer, and the third electrolyte layer.

### CROSS REFERENCE TO RELATED APPLICATIONS

This application is based upon and claims the benefit of priority from prior Japanese Patent Application No. P2008-222355 filed on Aug. 29, 2008, entitled “NIOBIUM SOLID ELECTROLYTIC CAPACITOR”, the entire contents of which are incorporated herein by reference.

### BACKGROUND OF THE INVENTION

1. Field of the Invention

The invention relates to a niobium solid electrolytic capacitor.

2. Description of Related Art

In recent years, tantalum solid electrolytic capacitors using tantalum for an anode and a conductive polymer for an electrolyte have been developed. Such tantalum solid electrolytic capacitors have the characteristics of small equivalent series resistance (ESR) and small leakage current, and have widely been used for portable devices such as game machines and mobile phones. On the other hand, solid electrolytic capacitors with higher performance are demanded with the miniaturization of electronic equipment.

Under such circumstances, niobium solid electrolytic capacitors using niobium as an anode are attracting attention. Niobium has relative permittivity approximately 1.5 times larger than, and allows the capacitors to achieve higher capacities than tantalum oxide, which is a dielectric of tantalum. However, due to their large leakage current, such niobium solid electrolytic capacitors have not been fully put into practical use.

In order to solve the above-mentioned problem, there have been proposed: a capacitor in which vanadium is contained in niobium (for example, Japanese Patent Translation Publication No. 2003-535981); a capacitor in which an electrolyte layer has a two-layered structure, and the electrolyte layer on a cathode side is doped with dodecylbenzenesulfonic acid ion or sulfate ion (for example, Japanese Patent Application Publication No. 2000-150310); and a capacitor in which a nitride area is provided in a dielectric layer (for example, Japanese Patent Application Publication No. Hei 11-329902), etc.

### SUMMARY OF THE INVENTION

However, as a result of examinations, the inventors found that even use of these techniques can lead to neither a sufficient reduction in the leakage current, nor a sufficient reduction in the ESR properties.

An aspect of the invention provides a niobium solid electrolytic capacitor comprising: an anode comprising mainly niobium with nitrogen and at least one alloying element having a hardness that is higher than that of niobium; a dielectric layer containing nitrogen provided on a surface of the anode; an electrolyte layer made of a conductive polymer on the dielectric layer; and a cathode layer on the electrolyte layer. The electrolyte layer has a three-layered structure formed of a first electrolyte layer, a second electrolyte layer, and a third electrolyte layer, which are arranged in this order between the dielectric layer to the cathode layer. The second electrolyte layer and the third electrolyte layer contain alkyl substituted aromatic sulfonate. Conductivities of the respective electrolyte layers are increased in order of the first electrolyte layer, the second electrolyte layer, and the third electrolyte layer.

According to the aspect of the invention, the anode contains nitrogen and at least one kind of alloying element whose hardness is higher than that of niobium. By containing nitrogen and the above-mentioned alloying element in the anode, it is possible to suppress peeling of the anode and the dielectric layer due to stress occurring when a capacitor element is coated with an outer resin. For this reason, increase of the ESR and the leakage current can be suppressed. The above-mentioned alloying element is an element whose hardness is higher than that of niobium. By containing such an alloying element, hardness of the anode increases and ductility can be suppressed. Therefore, it seems that it is possible to suppress the peeling of anode and dielectric layer due to stress occurring when the capacitor element is coated with the outer resin. Alloying elements having hardness higher than that of niobium (hardness of 6.0) include, for example, vanadium (hardness of 7.0), silicon (hardness of 6.5), boron (hardness of 9.3), tantalum (hardness of 6.5), and the like.

Preferably, the alloying element is between 500 ppm to 2000 ppm in the anode. When this content is below 500 ppm, the anode hardness cannot sufficiently be increased, and an increase of ESR and leakage current may be suppressed insufficiently. When the content exceeds 2000 ppm, the anode embrittles, and it may not be preferable. A more preferable range of alloy element is 700 to 1500 ppm.

Moreover, preferably, the nitrogen in the anode is between 100 ppm to 5000 ppm. When the nitrogen content is below 100 ppm or exceeds 5000 ppm, defect generation in the dielectric layer may be suppressed insufficiently, and increase of the leakage current may be suppressed insufficiently. A more preferable range of nitrogen content in the anode is between 500 ppm to 3500 ppm.

According to the aspect of the invention, the dielectric layer contains nitrogen. Presence of nitrogen in the dielectric layer can suppress generation of defects in the dielectric layer, and can reduce the leakage current. Since a dielectric layer generally is formed by anodizing an anode, the dielectric layer can contain nitrogen from use of an anode containing nitrogen. Accordingly, preferably, the content of nitrogen in the dielectric layer is in a range corresponding to the range of the content of nitrogen in the anode.

Moreover, preferably, the dielectric layer contains phosphorus. By containing phosphorus in the dielectric layer, generation of defects in the dielectric layer can be further suppressed, and the leakage current can be further reduced. Moreover, the ESR can be further reduced by the presence of phosphorus.

The phosphorus in the dielectric layer may enter the dielectric layer by performing anodization in aqueous solution that contains at least one species selected from potassium hydrogen phosphate, dibasic sodium phosphate, and ammonium hydrogen phosphate as an electrolyte. Phosphorus also can be added to the dielectric layer by anodization using phosphate as an electrolyte. By performing anodization using such an electrolyte, a uniform and fine dielectric layer can be formed on a surface of the anode, and leakage current can be further reduced. Preferably, phosphorus in the dielectric layer is concentrated to a portion close to the surface of the dielectric layer, i.e., an interface between the dielectric layer and the electrolyte layer, as shown in the embodiment described later. However, the invention is not limited to such concentration of phosphorus in the dielectric layer.

Preferably, dielectric layer thickness is within 50 nm to 300 nm. When the thickness of the dielectric layer is less than 50 nm, the leakage current may increase since the dielectric layer is not thick enough. Moreover, when the thickness of the dielectric layer exceeds 300 nm, the anode and the dielectric layer may peel off easily due to stress when coating the outer resin. For that reason, increase in ESR and in leakage current may be suppressed insufficiently. A more preferable thickness of the dielectric layer is between 75 nm to 250 nm.

According to the aspect of the invention, the electrolyte layer has a three-layered structure formed of a first electrolyte layer, a second electrolyte layer, and a third electrolyte layer from the anode side. The second electrolyte layer and the third electrolyte layer contain alkyl substituted aromatic sulfonate. Conductivities of the respective electrolyte layers increase in order of the first electrolyte layer, the second electrolyte layer, and the third electrolyte layer. This configuration brings about remarkable reduction of the ESR, by using such a electrolyte layer composition having the first electrolyte layer, the second electrolyte layer, and the third electrolyte layer as mentioned above.

As the alkyl substituted aromatic sulfonate contained in the second electrolyte layer and the third electrolyte layer, linear alkyl substituted aromatic sulfonates are preferable to branched alkyl substituted aromatic sulfonates, since linear alkyl substituted aromatic sulfonates have a larger effect of ESR reduction.

Linear alkyl substituted aromatic sulfonates include, for example, the following:

methylbenzenesulfonic acid sodium, butylbenzenesulfonic acid sodium, octylbenzenesulfonic acid sodium, and dodecylbenzenesulfonic acid sodium;

methylbenzenesulfonic acid potassium, butylbenzenesulfonic acid potassium, octylbenzenesulfonic acid potassium, and dodecylbenzenesulfonic acid potassium;

methylbenzenesulfonic acid ammonium, butylbenzenesulfonic acid ammonium, octylbenzenesulfonic acid ammonium, and dodecylbenzenesulfonic acid ammonium;

methylnaphthalenesulfonic acid sodium, butylnaphthalenesulfonic acid sodium, octylnaphthalenesulfonic acid sodium, and dodecylnaphthalenesulfonic acid sodium;

methylnaphthalenesulfonic acid potassium, butylnaphthalenesulfonic acid potassium, octylnaphthalenesulfonic acid potassium, and dodecylnaphthalenesulfonic acid potassium; and

methylnaphthalenesulfonic acid ammonium, butylnaphthalenesulfonic acid ammonium, octylnaphthalenesulfonic acid ammonium, and dodecylnaphthalenesulfonic acid ammonium.

It seems that the alkyl substituted aromatic sulfonate contained in the second electrolyte layer and the third electrolyte layer functions as a dopant of a conductive polymer.

The alkyl substituted aromatic sulfonate in the second electrolyte and the third electrolyte can be contained therein by including alkyl substituted aromatic sulfonate in monomer solution of a conductive polymer that forms these second and third electrolyte layers. Preferably, the alkyl substituted aromatic sulfonate concentration is between 1 to 20 parts by weight relative to 100 parts by weight of a monomer of the conductive polymer. When the alkyl substituted aromatic sulfonate concentration is too small, an electrolyte layer having high conductivity cannot be formed, and the ESR may be reduced insufficiently. Moreover, when the concentration of the alkyl substituted aromatic sulfonate is too large, adhesion between the conductive polymer layers may be reduced, and the ESR may be reduced insufficiently.

Dodecylbenzenesulfonic acid salt is preferably used as the linear alkyl substituted aromatic sulfonate contained in the second electrolyte layer. Moreover, butylnaphthalenesulfonic acid salt is preferably used as the linear alkyl substituted aromatic sulfonate in the third electrolyte layer.

According to the aspect of the invention, the conductivities of the respective electrolyte layers are higher in order of the first electrolyte layer, the second electrolyte layer, and to the third electrolyte layer. The first electrolyte layer, the second electrolyte layer, and the third electrolyte layer each having a different conductivity as mentioned above can be formed, for example, by changing the content or the kind of alkyl substituted aromatic sulfonate contained in the electrolyte layer. For example, an electrolyte layer without alkyl substituted aromatic sulfonate may be formed as the first electrolyte layer, an electrolyte layer containing alkyl substituted aromatic sulfonate may be formed as the second electrolyte layer, and an electrolyte layer containing alkyl substituted aromatic sulfonate that gives a conductivity higher than that of the alkyl substituted aromatic sulfonate contained in the second electrolyte layer may be formed as the third electrolyte layer. Thereby, conductivity in each electrolyte layer can be changed.

Moreover, a conductive polymer that forms the first electrolyte layer, the second electrolyte layer, and the third electrolyte layer includes at least one kind selected from polypyrrole, polythiophene, and polyaniline, for example.

Therefore, according to the aspect of the invention, a niobium solid electrolytic capacitor with reduced ESR and leakage current can be provided.

### BRIEF DESCRIPTION OF THE DRAWINGS

FIG. 1 is a schematic sectional view showing a niobium solid electrolytic capacitor according to one embodiment; and

FIG. 2 is a graph showing a result of an analysis on a dielectric layer in Example 1, the analysis performed in a thickness direction by XPS.

### DETAILED DESCRIPTION OF EMBODIMENTS

Hereinafter, the invention will be described further in detail on the basis of one embodiment. However, the invention is not limited to the following embodiment, and can be properly changed and can be performed within the scope in which the gist of the invention is not changed.

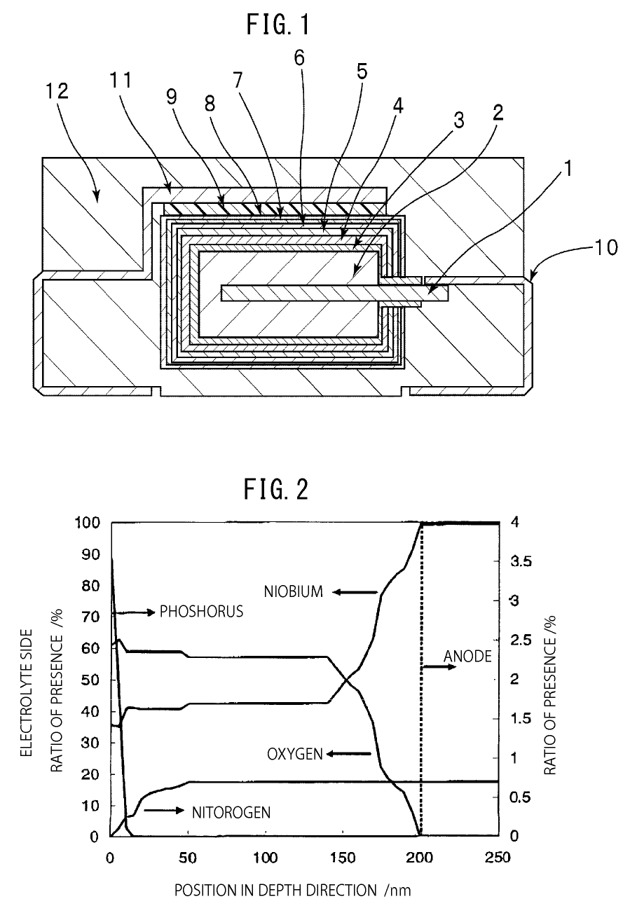

FIG. 1 is a schematic sectional view showing a niobium solid electrolytic capacitor according to one embodiment.

As shown in FIG. 1, anode lead wire 1 is embedded in anode 2, and dielectric layer 3 is formed on a surface of anode 2. On dielectric layer 3, first electrolyte layer 4, second electrolyte layer 5, and third electrolyte layer 6 are formed in this order. Carbon layer 7 and silver paste layer 8 are formed on a circumferential surface of third electrolyte layer 6 in this order. A cathode layer is formed of carbon layer 7 and silver paste layer 8. Cathode terminal 11 is connected to silver paste layer 8 through electrically conductive adhesive layer 9, and anode terminal 10 is connected to anode lead wire 1. Mold resin 12 is formed so that an end of anode terminal 10 and an end of cathode terminal 11 are withdrawn to the outside of mold resin 12. Hereinafter, more detailed description on the niobium solid electrolytic capacitor shown in FIG. 1 will be given.

As shown in FIG. 1, anode lead wire 1 is embedded in anode 2. Anode 2 is formed of a niobium alloy mainly made of niobium and containing an alloying element. As the alloying element, at least one kind of element whose hardness is higher than that of niobium is used. Preferably, niobium is present at not less than 50% by weight. Anode 2 is a porous body obtained by sintering niobium alloy powder formed of such a niobium alloy. When sintering the niobium alloy powder, anode lead wire 1 may be embedded. Similarly to the case of anode 2, anode lead wire 1 may be formed of the niobium alloy, or may be formed of other valve metals. The valve metals include, for example, niobium, hafnium, tantalum, aluminum, titanium, and zirconium.

As the niobium alloy powder that forms anode 2, a powdered product obtained by grinding an alloy can be used, the alloy obtained by adding an alloying element to niobium powder, and then alloying the mixture by melting. Moreover, a method for incorporating nitrogen into anode 2 includes, for example, a method of subjecting the niobium alloy powder to nitriding treatment in a nitrogen atmosphere at a high temperature and high pressure. However, nitrogen may be put into anode 2 by other methods.

Dielectric layer 3 is formed on the surface of anode 2. Dielectric layer 3 can be formed by anodizing anode 2 as mentioned above. Since anode 2 is a porous body as mentioned above, anode 2 is formed in a state such that dielectric layer 3 enters an inside surface of the porous body that forms the anode. Nitrogen is contained in dielectric layer 3, which is formed by anodizing anode 2 containing nitrogen as mentioned above. Dielectric layer 3 also contains phosphorus. Phosphorus in dielectric layer 3 can be put into dielectric layer 3, for example, by anodizing anode 2 using aqueous solution containing phosphorus.

On dielectric layer 3, first electrolyte layer 4, second electrolyte layer 5, and third electrolyte layer 6 are formed in this order. Second electrolyte layer 5 and third electrolyte layer 6 contain alkyl substituted aromatic sulfonate. Moreover, the conductivities of the respective electrolyte layers are higher in increasing order of first electrolyte layer 4, second electrolyte layer 5, and third electrolyte layer 6. These electrolyte layers can be formed by chemical polymerization or electrolytic polymerization. Out of these first electrolyte layer 4, second electrolyte layer 5, and third electrolyte layer 6, at least first electrolyte layer 4 is also formed in an inside surface of dielectric layer 3 formed in the inside surface of the porous body that forms anode 2. Accordingly, while first electrolyte layer 4, second electrolyte layer 5, and third electrolyte layer 6 are formed on dielectric layer 3 on a circumferential surface of anode 2 in the invention, an electrolyte layer having such a three-layered structure does not always need to be formed in the inside surface of the porous body that forms anode 2, and only first electrolyte layer 4 or only first electrolyte layer 4 and second electrolyte layer 5 may be formed.

On third electrolyte layer 6 above the circumferential surface of anode 2, carbon layer 7 and silver paste layer 8 are formed in this order. A cathode layer is formed of carbon layer 7 and silver paste layer 8. Carbon layer 7 can be formed by coating carbon paste on a circumferential surface of third electrolyte layer 6. Silver paste layer 8 can be formed by coating silver paste on carbon layer 7.

Cathode terminal 11 is connected to silver paste layer 8 through electrically conductive adhesive layer 9. Anode terminal 10 is connected to anode lead wire 1. Mold resin 12 is formed so that the end of anode terminal 10 and the end of cathode terminal 11 may be withdrawn to the outside.

In the invention, peeling off of anode 2 and dielectric layer 3 due to stress occurring at the time of forming mold resin 12 can be suppressed, thereby suppressing increase of the ESR and the leakage current. Moreover, since the electrolyte layer is formed of first electrolyte layer 4, second electrolyte layer 5, and third electrolyte layer 6, the ESR can be reduced significantly.

### Preliminary Experiment

A preliminary experiment below is performed to measure the conductivities of the first electrolyte layer, the second electrolyte layer, and the third electrolyte layer, respectively, to be formed in examples below.

### Preliminary Experiment 1

A platinum plate having a thickness of 0.1 mm is immersed for 5 minutes in aqueous solution obtained by mixing 1.0% by weight of hydrogen peroxide and 1.0% by weight of sulfuric acid. Subsequently, the platinum plate is reacted with pyrrole for 30 minutes to form a polypyrrole layer on a surface of the platinum plate by chemical polymerization.

### Preliminary Experiment 2

A platinum plate having a thickness of 0.1 mm is immersed in aqueous solution obtained by mixing 1.0% by weight of pyrrole and 0.2% by weight of linear dodecylbenzenesulfonic acid sodium. Anode polarization is performed at 1.5 V for 5 hours to form a polypyrrole layer on the platinum plate surface by electrolytic polymerization.

### Preliminary Experiment 3

A platinum plate having a thickness of 0.1 mm is immersed in solution obtained by mixing 1.0% by weight of pyrrole and 0.2% by weight of linear butylnaphthalenesulfonic acid sodium. Anode polarization is performed at 1.5 V for 5 hours to form a polypyrrole layer on the surface of the platinum plate by electrolytic polymerization.

### Measurement of Conductivity

The conductivities of the respective polypyrrole layers formed in preliminary experiments 1 to 3 are measured. The result is as follows.
Polypyrrole layer of preliminary experiment 1: 10⁻⁴ S/cm
Polypyrrole layer of preliminary experiment 2: 5 S/cm
Polypyrrole layer of preliminary experiment 3: 10 S/cm

As shown above, the conductivity of the polypyrrole layer of preliminary experiment 3 is the highest, followed by the polypyrrole layer of preliminary experiment 2, and the polypyrrole layer of preliminary experiment 1 in this order.

### Examples

Hereinafter, while the invention will be described using specific examples, the invention is not limited to the examples below.

### Example 1

### Step 1: Production of the Anode

An amount of 1000 ppm of vanadium is added to niobium, and the mixture is alloyed by melting at 2500° C. Subsequently, the obtained alloy is ground to produce niobium-vanadium alloy powder having a mean particle diameter of 2 μm.

This niobium-vanadium alloy powder is subjected to nitriding treatment by maintaining the powder for 30 minutes under a nitrogen atmosphere of 300° C. and of 500 torr. Quantitative analysis is carried out in accordance with the method specified by Japanese Industrial Standard (JIS) G 1201. As a result, 1000 ppm of nitrogen is contained in the niobium-vanadium alloy powder.

The anode made of a porous sintered body is produced by embedding a tantalum metal lead wire in this alloy powder and sintering this powder at approximately 1400° C.

### Step 2: Formation of the Dielectric Layer

The above-mentioned anode is oxidized at a constant voltage of 80 V for 10 hours in aqueous solution of 0.1% by weight of dibasic sodium phosphate maintained at 40° C. Then, the dielectric layer mainly made of niobium oxide is formed on the surface of the anode.

FIG. 2 is a drawing showing a result when analyzing this dielectric layer in a depth direction thereof by an X-ray photoelectron spectroscopy (XPS) analysis apparatus. Note that contained amounts of niobium and oxygen are shown with reference to the left side Y axis in FIG. 2 and contained amounts of phosphorus and nitrogen are shown with reference to the right side Y axis in FIG. 2. Apparently from FIG. 2, it turns out that a thickness of the dielectric layer is 200 nm, and nitrogen in the dielectric layer is contained at approximately the same proportion as that of nitrogen contained in the inside of the anode. The content of nitrogen becomes smaller in an area closer to the surface of the dielectric layer, i.e., an interface with the electrolyte layer. It also turns out that the content of phosphorus becomes larger in the area closer to the surface of the dielectric layer, i.e., the interface with the electrolyte layer. Accordingly, it turns out that phosphorus is concentrated to the surface of the dielectric layer.

### Step 3: Formation of the First Electrolyte Layer

Next, with chemical polymerization, the first electrolyte layer made of polypyrrole is formed on the surface of the dielectric layer produced at Step 2. A thickness of the first electrolyte layer is 2 nm.

This first electrolyte layer is formed under approximately the same conditions as those of preliminary experiment 1, and it seems that the first electrolyte layer has an approximately same conductivity as that of the polypyrrole layer in preliminary experiment 1.

### Step 4: Formation of the Second Electrolyte Layer

After Step 3, the anode is subjected to electrolytic polymerization for 5 hours in aqueous solution obtained by mixing 1.0% by weight of pyrrole and 0.2% by weight of linear dodecylbenzenesulfonic acid sodium (DBS—Na). Thereby, a polypyrrole layer including linear dodecylbenzenesulfonic acid sodium is formed as the second electrolyte layer. A thickness of the second electrolyte layer is 20 nm.

Since this second electrolyte layer is formed under the same conditions as those of preliminary experiment 2, it seems that the second electrolyte layer has approximately the same conductivity as that of the polypyrrole layer in preliminary experiment 2.

### Step 5: Formation of the Third Electrolyte Layer

After Step 4, the anode is subjected to electrolytic polymerization for 5 hours by immersing in aqueous solution obtained by mixing 1.0% by weight of pyrrole and 0.2% by weight of linear butylnaphthalenesulfonic acid sodium (BNS—Na). Thereby, a polypyrrole layer including linear butylnaphthalenesulfonic acid sodium is formed as the third electrolyte layer. A thickness of the third electrolyte layer is 20 nm.

Since this third electrolyte layer is formed under the same conditions as those of preliminary experiment 3, it seems that the third electrolyte layer has approximately the same conductivity as that of the polypyrrole layer in preliminary experiment 3.

### Step 6: Formation of the Carbon Layer and the Silver Paste Layer, and Formation of the Mold Resin

After Step 5, carbon paste is coated on a circumferential surface of the third electrolyte layer to form the carbon layer, and silver paste is coated thereon to form the silver paste layer. Furthermore, cathode terminal 11 is connected to the silver paste layer through the electrically conductive adhesive layer as mentioned above, and anode terminal 10 is connected to the anode lead wire. Coating with the mold resin is performed so that the end of each of these terminals may be withdrawn to the outside, and solid electrolytic capacitor A is produced.

### Example 2

Solid electrolytic capacitor A′ is produced in the same manner as in Example 1 except for the following. In the process of anodic oxidation at Step 2, instead of the aqueous solution of dibasic sodium phosphate, 0.1% by weight of hydrochloric acid is used for anodic oxidation.

In the example, as a result of XPS analysis, phosphorus is not formed in the dielectric layer.

### Example 3

Solid electrolytic capacitor A″ is produced in the same manner as in Example 1 except for the following. In the process of anodic oxidation at Step 2, instead of the aqueous solution of dibasic sodium phosphate, phosphoric acid aqueous solution is used for anodic oxidation.

In the Example, as seen by XPS analysis, phosphorus exists in the dielectric layer in the same manner as in the case of Example 1.

### Comparative Example 1

Solid electrolytic capacitor X1 is produced in the same manner as in Example 1 except that nitriding treatment at Step 1 of Example 1 is not performed.

### Comparative Example 2

Solid electrolytic capacitor X2 is produced in the same manner as in Example 1 except that, in a step corresponding to Step 1 of Example 1, the anode is formed using niobium metal powder (mean particle diameter of 2 μm) not including vanadium.

### Comparative Example 3

Solid electrolytic capacitor X3 is produced in the same manner as in Example 1 except that Step 5 of Example 1 is not performed.

### Comparative Example 4

Solid electrolytic capacitor X4 is produced in the same manner as in Example 1 except that, in a step corresponding to Step 1 of Example 1, niobium metal powder (mean particle diameter of 2 μm) not including vanadium is used, and the niobium metal powder not subjected to nitriding treatment is used to form the anode.

### Comparative Example 5

Solid electrolytic capacitor X5 is produced in the same manner as in Example 1 except that the sequence of Step 4 and Step 5 in Example 1 is reversed.

### Measurement of ESR and Leakage Current

The ESR and the leakage current are measured for each of the above-mentioned solid electrolytic capacitors.

The ESR is measured using an LCR meter at a frequency of 100 kHz. For measuring the leakage current, ¼ of a voltage of anodic oxidation voltage is applied, and a value after 20 seconds is measured. Table 1 shows the measurement result.

Each ESR value shown in Table 1 is a relative value for when the ESR of solid electrolytic capacitor A is defined as 100, and is calculated by the following (formula 1). Moreover, each values of leakage current shown in Table 1 is a relative value wherein the leakage current of solid electrolytic capacitor A is defined as 100, and is calculated by the following (formula 2).

ESR=[Measured value of ESR of solid electrolytic capacitor to be measured (mΩ)/measured value of ESR of solid electrolytic capacitor A (mΩ)]×100 (Formula 1)

Leakage current=[Measured value (mA) of leakage current of solid electrolytic capacitor to be measured/measured value of leakage current of solid electrolytic capacitor A (mA)]×100 (Formula 2)

TABLE 1

| | | | Phosphorus | Kind of salt included | | | |
|---|---|---|---|---|---|---|---|
| | | | in | 2nd | 3rd | | |
| | Alloying | Nitriding | dielectric | electrolyte | electrolyte | | Leakage |
| | element | treatment | layer | layer | layer | ESR | current |
| Solid | Vanadium | done | contained | DBs-Na | BNS-na | 100 | 100 |
| electrolytic | | | | | | | |
| capacitor A | | | | | | | |
| Solid | Vanadium | done | not | DBs-Na | BNS-na | 135 | 125 |
| electrolytic | | | contained | | | | |
| capacitor A′ | | | | | | | |
| Solid | Vanadium | done | contained | DBs-Na | BNS-na | 120 | 121 |
| electrolytic | | | | | | | |
| capacitor A″ | | | | | | | |
| Solid | Vanadium | not done | contained | DBs-Na | BNS-na | 388 | 200 |
| electrolytic | | | | | | | |
| capacitor X1 | | | | | | | |
| Solid | — | done | contained | DBs-Na | BNS-na | 382 | 373 |
| electrolytic | | | | | | | |
| capacitor X2 | | | | | | | |
| Solid | Vanadium | done | contained | DBs-Na | BNS-na | 251 | 122 |
| electrolytic | | | | | | | |
| capacitor X3 | | | | | | | |
| Solid | — | not done | contained | DBs-Na | BNS-na | 401 | 480 |
| electrolytic | | | | | | | |
| capacitor X4 | | | | | | | |
| Solid | Vanadium | done | contained | BNS-na | DBs-Na | 501 | 102 |
| electrolytic | | | | | | | |
| capacitor X5 | | | | | | | |

As shown in Table 1, it turns out that, in solid electrolytic capacitors A, A′, and A″ according to the invention, the ESR and the leakage current are reduced significantly compared to comparative examples of solid electrolytic capacitors X1 to X5.

Comparison of solid electrolytic capacitor A with solid electrolytic capacitor X1 shows that the ESR and the leakage current can be reduced by including nitrogen in the anode and the dielectric layer.

Comparison of solid electrolytic capacitor A with solid electrolytic capacitor X2 shows that the ESR and the leakage current can be reduced significantly by including an alloying element in the anode.

Comparison of solid electrolytic capacitor A with solid electrolytic capacitor X3 shows that the ESR and the leakage current can be reduced by providing the third electrolyte layer.

Comparison of solid electrolytic capacitor A with solid electrolytic capacitor X4 shows that the ESR and the leakage current increase significantly when an alloying element is not included in the anode, and when nitrogen is not included in the anode and the dielectric layer.

Comparison of solid electrolytic capacitor A with solid electrolytic capacitor X5 shows that the ESR can be reduced significantly when the conductivities of the respective electrolyte layers are higher in increasing order of the first electrolyte layer, the second electrolyte layer, and the third electrolyte layer.

### Examples 4 to 30

Here, a relationship between the content of vanadium in the anode and reduction in the ESR and the leakage current is considered.

Solid electrolytic capacitors A1 to A19 are produced in the same manner as in Example 1 except that, instead of 1000 ppm, the contents of vanadium are 300 ppm, 400 ppm, 500 ppm, 600 ppm, 700 ppm, 800 ppm, 900 ppm, 1100 ppm, 1200 ppm, 1300 ppm, 1400 ppm, 1500 ppm, 1600 ppm, 1700 ppm, 1800 ppm, 1900 ppm, 2000 ppm, 2100 ppm, and 2200 ppm, respectively, as shown in Table 2.

Moreover, solid electrolytic capacitors A20 to A22 are produced in the same manner as in Example 1 except that niobium alloys used contain 700 ppm, 1000 ppm and 1500 ppm of silicon instead of vanadium, respectively.

Moreover, solid electrolytic capacitors A23 to A25 are produced in the same manner as in Example 1 except that niobium alloys used to form the anode contain 700 ppm, 1000 ppm and 1500 ppm of boron instead of vanadium, respectively.

Moreover, solid electrolytic capacitor A26 is produced in the same manner as in Example 1 except that a niobium alloy used to produce the anode contains 1000 ppm of tantalum instead of vanadium.

Moreover, solid electrolytic capacitor A27 is produced in the same manner as in Example 1 except that a niobium alloy used to form the anode contains 500 ppm of boron and 500 ppm of vanadium.

For each solid electrolytic capacitor produced as mentioned above, the ESR and the leakage current are measured in the same manner as mentioned above, and the results are shown in Table 2.

Table 2 also shows the value of solid electrolytic capacitor A.

TABLE 2

| | | Percentage | | |
|---|---|---|---|---|
| | | of | | |
| | | alloying | | |
| | Kind of | element | | |
| | alloying | contained | | Leakage |
| | element | (ppm) | ESR | current |
| Solid electrolytic capacitor A1 | Vanadium | 300 | 158 | 163 |
| Solid electrolytic capacitor A2 | Vanadium | 400 | 159 | 163 |
| Solid electrolytic capacitor A3 | Vanadium | 500 | 116 | 115 |
| Solid electrolytic capacitor A4 | Vanadium | 600 | 115 | 114 |
| Solid electrolytic capacitor A5 | Vanadium | 700 | 99 | 102 |
| Solid electrolytic capacitor A6 | Vanadium | 800 | 100 | 98 |
| Solid electrolytic capacitor A7 | Vanadium | 900 | 101 | 105 |
| Solid electrolytic capacitor A | Vanadium | 1000 | 100 | 100 |
| Solid electrolytic capacitor A8 | Vanadium | 1100 | 102 | 99 |
| Solid electrolytic capacitor A9 | Vanadium | 1200 | 100 | 101 |
| Solid electrolytic capacitor A10 | Vanadium | 1300 | 102 | 99 |
| Solid electrolytic capacitor A11 | Vanadium | 1400 | 100 | 102 |
| Solid electrolytic capacitor A12 | Vanadium | 1500 | 103 | 103 |
| Solid electrolytic capacitor A13 | Vanadium | 1600 | 114 | 113 |
| Solid electrolytic capacitor A14 | Vanadium | 1700 | 114 | 114 |
| Solid electrolytic capacitor A15 | Vanadium | 1800 | 115 | 113 |
| Solid electrolytic capacitor A16 | Vanadium | 1900 | 115 | 114 |
| Solid electrolytic capacitor A17 | Vanadium | 2000 | 114 | 116 |
| Solid electrolytic capacitor A18 | Vanadium | 2100 | 162 | 161 |
| Solid electrolytic capacitor A19 | Vanadium | 2200 | 160 | 162 |
| Solid electrolytic capacitor A20 | Silicon | 700 | 104 | 103 |
| Solid electrolytic capacitor A21 | Silicon | 1000 | 101 | 100 |
| Solid electrolytic capacitor A22 | Silicon | 1500 | 102 | 102 |
| Solid electrolytic capacitor A23 | Silicon | 700 | 103 | 103 |
| Solid electrolytic capacitor A24 | Silicon | 1000 | 100 | 101 |
| Solid electrolytic capacitor A25 | Silicon | 1500 | 103 | 103 |
| Solid electrolytic capacitor A26 | Tantalum | 1000 | 225 | 230 |
| Solid electrolytic capacitor A27 | Boron | 500 | 100 | 101 |
| | Vanadium | 500 | | |

Apparently from the results of testing solid electrolytic capacitors A and A1 to A19, the ESR and the leakage current can be reduced by including vanadium in the anode. It turns out that the ESR and the leakage current can be further reduced when the content of vanadium is 500 ppm to 2000 ppm, and particularly, when the content of vanadium is in a range of 700 ppm to 1500 ppm, the ESR and the leakage current can be still more reduced.

Apparently from the results of solid electrolytic capacitors A20 to A25, it turns out that, also when silicon or boron is included as the alloying element in the anode instead of vanadium, an effect of reduction of the ESR and the leakage current is obtained in a range of 700 to 1500 ppm in the same manner as in the case of vanadium.

Moreover, apparently from the result of solid electrolytic capacitor A26, it turns out that, also when tantalum is used as the alloying element, the ESR and the leakage current can be reduced, and a result more satisfactory than those of the solid electrolytic capacitors of comparative examples shown in Table 1 is obtained. However, a more remarkable effect is obtained in the cases where vanadium, silicon, and boron are used as an alloying element than the case where tantalum is used as the alloying element.

Apparently from the result of solid electrolytic capacitor A27, it turns out that an effect of the invention is obtained also when two or more kinds of alloying elements are included.

### Examples 31 to 42

Here, a relationship between a content of nitrogen in the anode and reduction of the ESR and the leakage current is considered.

Solid electrolytic capacitors B1 to B12 are produced in the same manner as in Example 1 except that the temperatures of nitriding treatments are 100° C., 150° C., 200° C., 250° C., 350° C., 400° C., 450° C., 500° C., 550° C., 600° C., 650° C., and 700° C., respectively, instead of 300° C. in Step 1 of Example 1.

For each produced solid electrolytic capacitor, the ESR and the leakage current are measured. The measurement results are shown in Table 3. Values of the ESR and values of the leakage current in Table 3 are relative values wherein a corresponding value of solid electrolytic capacitor A is defined as 100. Table 3 also shows the values of solid electrolytic capacitor A.

Moreover, the content of nitrogen contained in the anode is measured by the same method as that described in Step 1 of Example 1, and is shown in Table 3.

TABLE 3

| | Temperature of | Nitrogen | | |
|---|---|---|---|---|
| | nitriding | contained in | | Leakage |
| | treatment (° C.) | anode (ppm) | ESR | current |
| Solid electrolytic | 100 | 50 | 155 | 159 |
| capacitor B1 | | | | |
| Solid electrolytic | 150 | 100 | 114 | 114 |
| capacitor B2 | | | | |
| Solid electrolytic | 200 | 200 | 115 | 116 |
| capacitor B3 | | | | |
| Solid electrolytic | 250 | 500 | 101 | 101 |
| capacitor B4 | | | | |
| Solid electrolytic | 300 | 1000 | 100 | 100 |
| capacitor A | | | | |
| Solid electrolytic | 350 | 1500 | 100 | 99 |
| capacitor B5 | | | | |
| Solid electrolytic | 400 | 2000 | 99 | 101 |
| capacitor B6 | | | | |
| Solid electrolytic | 450 | 3500 | 101 | 10 |
| capacitor B7 | | | | |
| Solid electrolytic | 500 | 4000 | 114 | 113 |
| capacitor B8 | | | | |
| Solid electrolytic | 550 | 4500 | 115 | 113 |
| capacitor B9 | | | | |
| Solid electrolytic | 600 | 5000 | 114 | 115 |
| capacitor B10 | | | | |
| Solid electrolytic | 650 | 5500 | 154 | 156 |
| capacitor B11 | | | | |
| Solid electrolytic | 700 | 6000 | 156 | 157 |
| capacitor B12 | | | | |

Apparently from the results shown in Table 3, it turns out that, when the content of nitrogen in the anode is between 100 ppm to 5000 ppm, the ESR and the leakage current are further reduced, thereby this range being preferable. Especially, it is more preferable when the content of nitrogen is between 500 ppm to 3500 ppm.

### Examples 43 to 56

Here, a relationship between the thickness of the dielectric layer and reduction of the ESR and the leakage current is considered. Solid electrolytic capacitors C1 to C14 are produced by the same method as that in Example 1 except that the voltages in the anodic oxidations are 12V, 16V, 20V, 30V, 40V, 50V, 60V, 70V, 90V, 100V, 110V, 120V, 130V, and 140V, respectively, instead of 80V in Step 1 of example 1.

For each obtained solid electrolytic capacitor, the ESR and the leakage current are measured in the same manner as mentioned above. Values of the ESR and values of the leakage current shown in Table 4 are relative values wherein a corresponding value of solid electrolytic capacitor A is defined as 100. Table 4 also shows the values of solid electrolytic capacitor A.

A thickness of the dielectric layer in each solid electrolytic capacitor is measured, and is shown in Table 4.

TABLE 4

| | Voltage of | Thickness of | | |
|---|---|---|---|---|
| | anodic oxidation | dielectric layer | | Leakage |
| | (V) | (nm) | ESR | current |
| Solid electrolytic | 12 | 30 | 156 | 161 |
| capacitor C1 | | | | |
| Solid electrolytic | 16 | 40 | 154 | 161 |
| capacitor C2 | | | | |
| Solid electrolytic | 20 | 50 | 113 | 112 |
| capacitor C3 | | | | |
| Solid electrolytic | 30 | 75 | 99 | 100 |
| capacitor C4 | | | | |
| Solid electrolytic | 40 | 100 | 101 | 99 |
| capacitor C5 | | | | |
| Solid electrolytic | 50 | 125 | 100 | 101 |
| capacitor C6 | | | | |
| Solid electrolytic | 60 | 150 | 101 | 99 |
| capacitor C7 | | | | |
| Solid electrolytic | 70 | 175 | 101 | 100 |
| capacitor C8 | | | | |
| Solid electrolytic | 80 | 200 | 100 | 100 |
| capacitor A | | | | |
| Solid electrolytic | 90 | 225 | 100 | 101 |
| capacitor C9 | | | | |
| Solid electrolytic | 100 | 250 | 102 | 101 |
| capacitor C10 | | | | |
| Solid electrolytic | 110 | 275 | 113 | 113 |
| capacitor C11 | | | | |
| Solid electrolytic | 120 | 300 | 113 | 112 |
| capacitor C12 | | | | |
| Solid electrolytic | 130 | 325 | 155 | 161 |
| capacitor C13 | | | | |
| Solid electrolytic | 140 | 350 | 157 | 159 |
| capacitor C14 | | | | |

Apparently from the results shown in Table 4, it turns out that, as for the thickness of the dielectric layer, a range of 50 nm to 300 nm is preferable, and a range of 75 nm to 250 nm is more preferable.

The invention includes other embodiments without deviating from the gist of the invention, in addition to what has been described in the embodiment. The embodiments illustrate the invention, and do not limit the scope thereof. The scope of the invention is defined by the description of claims, and not by the description herein. Accordingly, the invention includes all the embodiments within the scope of claims and within a sense equivalent to the scope of claims.

What is claimed is:

1. A niobium solid electrolytic capacitor comprising:
an anode comprising mainly niobium with nitrogen and at least one alloying element having a hardness that is higher than that of niobium;
a dielectric layer containing nitrogen provided on a surface of the anode;
an electrolyte layer made of a conductive polymer on the dielectric layer; and
a cathode layer on the electrolyte layer, wherein
the electrolyte layer has a three-layered structure formed of a first electrolyte layer, a second electrolyte layer, and a third electrolyte layer, which are arranged in this order between the dielectric layer to the cathode layer,
the second electrolyte layer and the third electrolyte layer contain alkyl substituted aromatic sulfonate, and
conductivities of the respective electrolyte layers are increased in order of the first electrolyte layer, the second electrolyte layer, and the third electrolyte layer.

2. The niobium solid electrolytic capacitor according to claim 1, wherein the dielectric layer contains phosphorus.

3. The niobium solid electrolytic capacitor according to claim 2, wherein the phosphorus contained in the dielectric layer is concentrated in the dielectric layer on a side facing the electrolyte layer.

4. The niobium solid electrolytic capacitor according to claim 1, wherein the alloying element is at least one of vanadium, silicon, and boron.

5. The niobium solid electrolytic capacitor according to claim 1, wherein the anode contains the alloying element in a range of 500 ppm to 2000 ppm.

6. The niobium solid electrolytic capacitor according to claim 5, wherein the anode contains the alloying element in a range of 700 to 1500 ppm.

7. The niobium solid electrolytic capacitor according to claim 1, wherein the anode contains the nitrogen in a range of 100 ppm to 5000 ppm.

8. The niobium solid electrolytic capacitor according to claim 7, wherein the anode contains the nitrogen in a range of 500 ppm to 3500 ppm.

9. The niobium solid electrolytic capacitor according to claim 1, wherein the thickness of the dielectric layer is in a range of 50 nm to 300 nm.

10. The niobium solid electrolytic capacitor according to claim 9, wherein the thickness of the dielectric layer is in a range of 75 nm to 250 nm.

11. The niobium solid electrolytic capacitor according to claim 1, wherein the alkyl substituted aromatic sulfonate contained in the second electrolyte layer and the third electrolyte layer is linear alkyl substituted aromatic sulfonate.

12. The niobium solid electrolytic capacitor according to claim 11, wherein the linear alkyl substituted aromatic sulfonate is selected from the group consisting of:
methylbenzenesulfonic acid sodium, butylbenzenesulfonic acid sodium, octylbenzenesulfonic acid sodium, and dodecylbenzenesulfonic acid sodium;
methylbenzenesulfonic acid potassium, butylbenzenesulfonic acid potassium, octylbenzenesulfonic acid potassium, and dodecylbenzenesulfonic acid potassium;
methylbenzenesulfonic acid ammonium, butylbenzenesulfonic acid ammonium, octylbenzenesulfonic acid ammonium, and dodecylbenzenesulfonic acid ammonium;
methylnaphthalenesulfonic acid sodium, butylnaphthalenesulfonic acid sodium, octylnaphthalenesulfonic acid sodium, and dodecylnaphthalenesulfonic acid sodium;
methylnaphthalenesulfonic acid potassium, butylnaphthalenesulfonic acid potassium, octylnaphthalenesulfonic acid potassium, and dodecylnaphthalenesulfonic acid potassium; and
methylnaphthalenesulfonic acid ammonium, butylnaphthalenesulfonic acid ammonium, octylnaphthalenesulfonic acid ammonium, and dodecylnaphthalenesulfonic acid ammonium.
